(19) United States
(12) Patent Application Publication
(10) Pub. No.: US 2005/0283419 A1
(43) Pub. Date: Dec. 22, 2005

(54) System and method for maximizing after-tax income using split method charitable remainder trusts

(76) Inventor: Benson L. Schaub, Phoenix, AZ (US)

Correspondence Address: KUNZLER & ASSOCIATES, 8 EAST BROADWAY, SALT LAKE CITY, UT, 84111, US

(21) Appl. No.: 11/158,681

(22) Filed: Jun. 22, 2005

Related U.S. Application Data
(60) Provisional application No. 60/581,805, filed on Jun. 22, 2004.

(51) Int. Cl. G06F 17/60

(52) U.S. Cl. 705/35

(57) ABSTRACT

A system, method, and apparatus are disclosed for maximizing after-tax income from trusts, including charitable remainder trusts, through balanced distribution of assets between fixed income and equity investments (and possibly tax free and return of principle) based on a customized risk benefit analysis tailored to the unique circumstances and preferences of an individual donor or investor, the customized risk benefit analysis preferably being performed by an investment evaluation service optionally comprising computer or electronic calculations.

### CROSS-REFERENCES TO RELATED APPLICATIONS

This application claims priority to U.S. Provisional Patent Application No. 60/581,805 entitled “System and Method for Planning for, Funding, and Administering a Dual (Split) Set of Charitable Remainder Trusts” and filed on Jun. 22, 2004, for Benson L. Schaub, which is incorporated herein by reference.

### BACKGROUND OF THE INVENTION

1. Field of the Invention

The present invention relates to the use of Charitable Remainder Trusts as defined in Section 664 of the Internal Revenue Code relative to charitable planning models. The illustrated embodiments present a new system and method of replacing what would be one new, or one existing CRT with two or more CRTs that each receive a proportion of the assets that would have gone into, or were in the one, managing one of the trusts in a way that maximizes fixed income or ordinary income, managing the second trust in a way that maximizes equity or long term capital gain growth (realized or unrealized). In certain cases, there may be a need for a third and fourth trust, managing the third trust (if there is a third) in a way that maximizes tax free income, and managing a fourth trust in a way that maximizes return of principle. For practical reasons, the split, in most cases, will only involve the first two trusts named above. In the case where appreciated assets are being transferred to a CRT and are then sold, there is a large accumulated capital gain on the books of the trust that will minimize any opportunity to benefit from the investment of tax free bonds or to obtain a return of principle. For this reason, the following description of this patent will focus on the management of the split into two trusts.

2. Description of the Related Art

A Charitable Remainder Trust (referring to either a Charitable Remainder Annuity Trust or a Charitable Remainder Unitrust and hereinafter referred to as a CRT) is a type of a deferred gift. The donor receives lifetime income and tax benefits and the gift to charities is deferred to a future time, usually the death of the donor or the end of a specified number of years. At the end of the designated time for income distributions, the trust terminates and the remainder left in the trust is distributed to one or more qualified charities. Under IRC section 664 amounts distributed by a charitable remainder trust shall be considered as having the following characteristics in the hands of a beneficiary:

“First, as amounts of income (other than gains, and amounts treated as gains, from the sale or other disposition of capital assets) includible in gross income to the extent of such income of the trust for the year and such undistributed income of the trust for prior years;

Second, as a capital gain to the extent of the capital gain of the trust for the year and the undistributed capital gain of the trust for prior years;

Third, as tax free income to the extent that there is tax free income to the trust for the year and the undistributed tax free income of the trust for prior years; and

Fourth, as a return of principle.”

The foregoing provisions apply in the case of a charitable remainder annuity trust (CRAT) and a charitable remainder unitrust (CRUT). A charitable remainder annuity trust is a trust from which not less than 5 percent of the initial net fair market value of all property placed in trust is to be paid at least annually, to one or more persons who are called income beneficiaries. Payments continue for a term of years (not in excess of 20 years) or for the life or lives of the beneficiaries. No other amount may be paid from the trust except to a charitable organization as described in section 170 C.

Following the termination of the payments, the remainder interest in the trust is transferred to a charitable organization as described in section 170 C or is retained by the trust for such a use.

A charitable remainder unitrust is a trust from which a fixed percentage of no less than 5 percent of the net fair market value of its assets, valued annually, is to be paid, at least annually, to one or more income beneficiaries. Payment continues for a term of years (not in excess of 20 years) or for the life or lives of the beneficiaries. No other amount may be paid from the trust except to a charitable organization as described in section 170 C.

Following the termination of the payments the remainder interest in the trust is to be transferred to, or for the use of, an organization described in section 170 C or is to be retained by the trust for such a use. Charitable remainder annuity trusts and charitable remainder unitrusts themselves are generally not subject to any tax imposed by section 664.

Need for Invention

The need for this invention arises from the potential tax disadvantage resulting from the tiered treatment of the income distributions to the income beneficiary, first as ordinary income, second as capital gain, third as tax free income, and fourth as return of principle

Potential Disadvantage of Current Art

Income generated within a CRT is taxed upon distribution. A CRT is required to first distribute any current or accumulated ordinary income that is within the trust. However, distribution of ordinary income is a disadvantage because of its relatively higher rate of taxation. The maximum tax rate for ordinary income is 35%, whereas the maximum capital gains rate is 15%.

Equity or growth investment income, the second tier, is taxed as capital gain. The disadvantage of investing in equity or growth investments, however, is the danger of market losses. Thus, equity investing is typically deemed to carry a higher risk. Perspectives on the best investment policy differ. The lifetime income beneficiary might predictably favor a more aggressive, although higher risk, approach and capital gains tax treatment. Therefore, the income beneficiary would prefer the trustee to invest only in growth or equity investments. This is especially true for younger donors. However, trust assets may be depleted when equity or growth investments perform poorly and lose, rather than gain, value. For example, if equity funds (in an all equity invested standard CRT) are down 10% for the year, the trustee is still required to make a full income distribution even if it has to come out of principle, which it would. A distribution out of the principle of the trust reduces the trust value and the eventual remainder value for the charity. The trust value could spiral down if there are consecutive down market years.

Consequently, the charitable remainder beneficiary may favor conservation of trust assets through a lower risk approach. Fixed income investments are typically deemed to be safer, with a lower risk of loss. The remainderman, therefore, would rather see the trust invested in fixed income types of investments such as bonds, CDs, government securities, etc., especially if it were possible to get fixed income returns that are high enough to pay the annual income beneficiary distributions.

This dichotomy presents a dilemma for the investment trustee who has a fiduciary duty to protect the best interests of both beneficiaries. The tiered income distribution order, as described above compounds the potential conflict between the individual “lifetime” interest beneficiary and the charitable remainder interest beneficiary. If the trustee invests the trust only in fixed income investments, the income beneficiary will be taxed on all of the trust income distributions at the higher regular income tax rates. If the trustee invests only in equity investments, he can be criticized for risking the preservation of the principle that is so important to the remainder beneficiary charity. At the very least, a trustee would be prudent to balance these interests.

As noted above, however, section 664 requires that ordinary income be distributed first. Therefore, if the trustee attempts to balance trust investments between fixed income and growth (such as 50% growth and 50% fixed income) within a single CRT he runs the risk that distributions will be disproportionately designated as ordinary income. This would occur when the fixed income returns are greater than the required income distribution amount. For example, a CRT containing $1 million may be required to pay 5% ($50,000) annually to the trust's income beneficiary. The trust may be invested 50%, or $500,000 in fixed income investment, and 50% or $500,000 in growth investments. Assuming that each type of investment generated an income of $50,000, the trust's fixed income return of $50,000 must be distributed first. Since $50,000 is the income distribution amount, the income beneficiary would have to treat his entire income distribution of $50,000 as ordinary income, taxed at more than twice the rate of capital gains.

What is needed is a system and method that maximizes the portion of income taxed as capital gains. Such a system and method would balance the interests of the income beneficiary and the charitable remainder beneficiary.

### SUMMARY OF THE INVENTION

The current invention solves this problem by establishing a plurality of CRTs, whereas before only one was used, or splitting an existing CRT into a plurality. Each CRT may then be classified according to the manner of income generation, ordinary income or capital gains income. The two or more CRTs are managed to maximize the ability of the income beneficiary to treat more of the income distribution as capital gains income, while simultaneously achieving a balanced investment policy.

For example, a $1,000,000 asset may be divided (split) with half($500,000) going into CRT 1 and the other half ($500,000) going into CRT 2. Each trust is required to pay $5%, ($25,000) annually to the income beneficiary for a total annual distribution of $50,000. CRT 1 ($500,000) may be invested in fixed income investments, and CRT 2 ($500,000) may be invested in growth investments. Both trusts, and the investments therein, may be equally successful, the first achieving a 10% return, and the second, a growth of 10%. The trust income from CRT 1 is still taxed as ordinary income at 35%. Now, however, the income form CRT 2 is taxed as capital gains at only 15%.

In one embodiment, the invention is a method of administering a plurality of charitable remainder trusts instead of using the prior art method of employing a single trust. In certain embodiments, the method comprises the steps of establishing a class of trust investing in fixed income opportunities, and a further class of trust investing in equities or growth investments. A distribution from the fixed income class trust is taxed as ordinary income, and the distribution from an equity investment class trust is taxed as capital gains income.

In a further embodiment of the invention, the method comprises the steps of splitting the assets of an existing CRT and transferring assets from this existing CRT into a new or separate CRT that continues to qualify as a CRT, and then managing this second CRT as a different investment class trust to achieve the described benefits of this invention. One of the trusts will invest in fixed income investments and the other will invest in growth or equity investments.

The method may also comprise the steps of controlling the percentage of distributions taxed as ordinary income versus capital gains by controlling the percentage of assets dedicated to funding each class of trust.

Those experienced in the art will recognize that a younger, more risk tolerant individual in a high income bracket might prefer the higher risk, with lower tax, equity investing CRT, while an older, more risk adverse individual in a lower tax bracket might choose to focus on the lower risk, although more highly taxed, fixed income investing CRT.

In many instances, a trustee of CRTs might feel obligated to use this new invention to safeguard his fiduciary responsibility to balance his investment policy and management approach. The present invention provides each trustee with the flexibility to respond to the priorities and circumstances of the individual beneficiaries. For example some trustees may find it imprudent to invest a high percentage (more than 50%) of assets in growth or equity investments, while for others fiduciary duty may dictate minimization of taxes and maximization of income. Splitting off a prudent portion of assets into an equity investment trust allows the CRT remainder beneficiary to control risk while removing the income beneficiary's risk that ordinary income will eliminate or reduce the amount of income that could otherwise be reported at the more favorable capital gains rate. Thus, the invention creates opportunities for ongoing advantages and has no known negative consequences.

The present invention provides a tax advantage in any year of a CRT where fixed income returns are greater than the gains on equity investments. There may be years where the advantage does not materialize; however, it is certain that there will be years where the advantage does materialize and, over time, the advantage is magnified and become more significant.

The utility of the invention transcends fluctuations in traditional fixed income investment returns. In most cases, the establishment of a CRT is not contingent on the investment trends of the moment. Donors typically do not delay CRT establishment until interest rates are high. Moreover, even today the diligent investigator can find safe, high income yielding, fixed income investments ranging from 10% to 14%. Furthermore, the opportunity to compensate for low fixed income rates by generating tax savings through diversification into higher yield investments may provide additional incentive for CRT creation in any market.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram depicting one embodiment of a split investment combination of a Fixed Income Investment Charitable Remainder Trust (CRT-1) and an Equity Investment Charitable Remainder Trust (CRT-2).

FIG. 2 is a schematic block diagram depicting one embodiment of distribution system for trust income from the CRT-1 and CRT-2 during the lifetime of the grantor.

FIG. 3 is a schematic block diagram depicting one embodiment of a distribution system for trust assets following the death of the grantor

FIG. 4 is a schematic flow chart diagram depicting one embodiment of a method for maximizing income to the grantor and income beneficiaries through use of a plurality of charitable remainder trusts and, upon the death of the grantor, passing the remainder of the estate to a charity; and

FIG. 5 is a schematic block diagram depicting one embodiment of an apparatus configured to evaluate the distribution of assets between the CRT-1 and the CRT-2.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, specific details are provided. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Individuals typically wish to minimize taxes on their assets and income, thus maximizing the amount available for themselves, their beneficiaries, and charitable giving. Various classes of trusts, including CRTs, provide an effective tax planning vehicle.

Under section 664 of the Internal Revenue Code, the source of income generation within a CRT determines how distributions will be treated in the hands of the trust's income beneficiary. Thus, distributions from a CRT generating ordinary income through fixed-income vehicles, such as CDs, government securities, mortgages, etc., will be taxed as ordinary income in the hands of the income beneficiary. Distributions from a trust generating income through long term growth in equity investments will be taxed as capital gains in the hands of the income beneficiary. In a balanced or mixed investment CRT, all distributions will be taxed as ordinary income until the distributions have exhausted the portion of the trust income generated by fixed income investments. Only then will the beneficiaries receive the benefit of the substantially lower capital gains rate on the distributions that they receive, even if equity investments generate a substantial portion of the trust income or growth. Under this existing system, neither the grantor nor the beneficiaries can exercise control over the percentage of distributions taxed as fixed income and as capital gains. If the fixed income investments supply income sufficient to cover the distributions, the grantor and other beneficiaries may never enjoy the benefit of the lower capital gains tax rate. The current invention provides a system and method for administering trusts so as to give the grantor greater control over the taxing of distributions. The drawings depict one embodiment of the system and method.

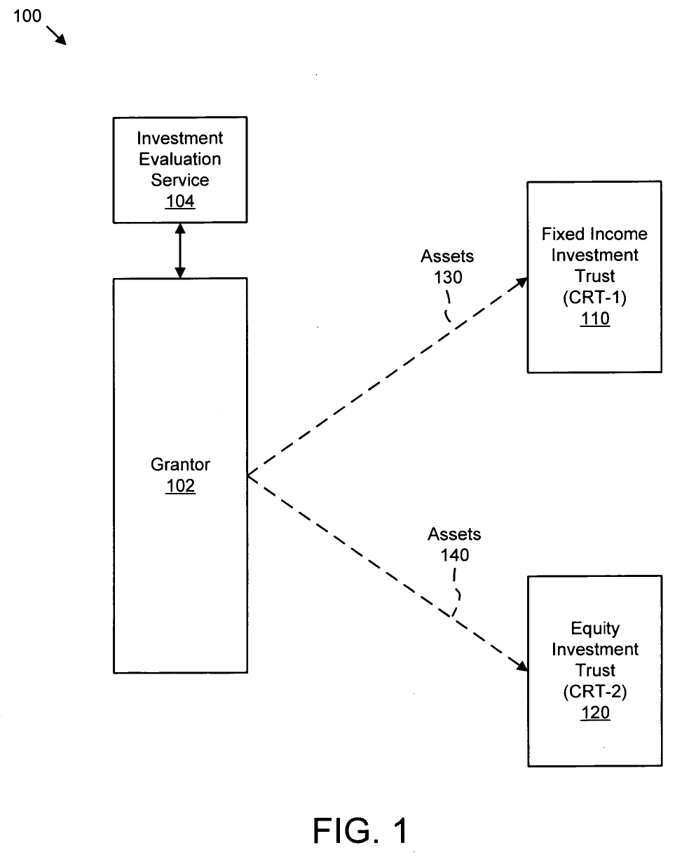

FIG. 1 is a schematic block diagram depicting one embodiment of split investment combination 100 of a Fixed Income Investment Trust (“CRT-1”) 110 and an Equity Investment Trust (“CRT-2”) 120. As depicted, the combination 100 includes a grantor 102, an investment evaluation service 104, a CRT-1 110, a CRT 2 120, assets 130 and assets 140. The grantor 102 is understood to include any investment advisor, financial service, trustee, or other representative of the grantor.

The investment evaluation service 104 analyzes the relative income and risk potential of fixed income investments and equity investments and combines these with information regarding the risk/benefit preferences of the grantor 102. The investment evaluation service 104 advises the grantor 102 regarding the distribution of assets 130, 140. The grantor 102 distributes assets 130 and 140 between the trusts according to preference. In so doing, the grantor 102 balances the lower risk, fixed earning rate and higher tax rate of the ordinary income investment type CRT-1 110 with the higher risk, variable growth rate, and lower tax rate of the equity or capital gain investment type CRT-2 120. Because the two income type generation mechanisms are separated into two CRTs, rather than combined in one, the grantor 102 may be sure that at least a portion of distributions will enjoy the lower capital gains tax rate.

In a further embodiment, the grantor 102 establishes CRT-1 110 and CRT-2 120 as charitable remainder annuity trusts (CRAT), wherein distributions are calculated as a percentage of the original value of the trust assets 130, 140. In a further embodiment, the grantor 102 establishes CRT-1 110 and CRT-2 120 as charitable remainder unitrusts (CRUT) wherein distributions are calculated as a percentage of the annual value of the trust assets. Alternatively, the grantor 102 may establish one of CRT-1 110 and CRT-2 120 as a CRAT and the other as a CRUT. In so doing, the grantor 102 considers the relative risk and earning capacity of fixed income and equity investments. For example, the grantor 102 may establish the lower risk and fixed earning fixed income trust as a CRAT, yielding fixed distribution income while gradually increasing the asset value of the trust and establish the higher risk, variable earning equity investment trust as a CRUT, which pays out higher income distributions as the trust corpus increases, but preserves the trust corpus by paying lower income distributions if the corpus diminishes.

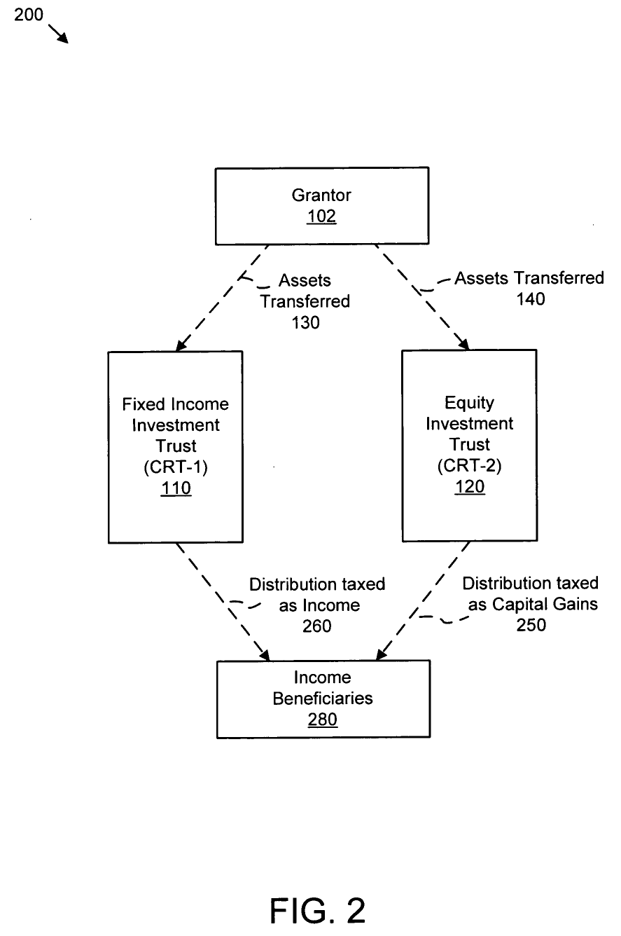

FIG. 2 is a schematic block diagram depicting one embodiment of a distribution system 200 for trust income from the CRT-1 110 and the CRT-2 120 during the lifetime of the grantor 102. As depicted, the distribution 200 comprises the grantor 102, the CRT-1 110, the CRT-2 120, assets transferred 130 and 140, income distribution 260, capital gains distribution 250 and beneficiaries 280.

Distributions 260 from the CRT-1 110 to the income beneficiaries 280, are taxed as ordinary income. Distributions 250 from the CRT-2 120 to the income beneficiaries 280 are taxed as long-term capital gains income.

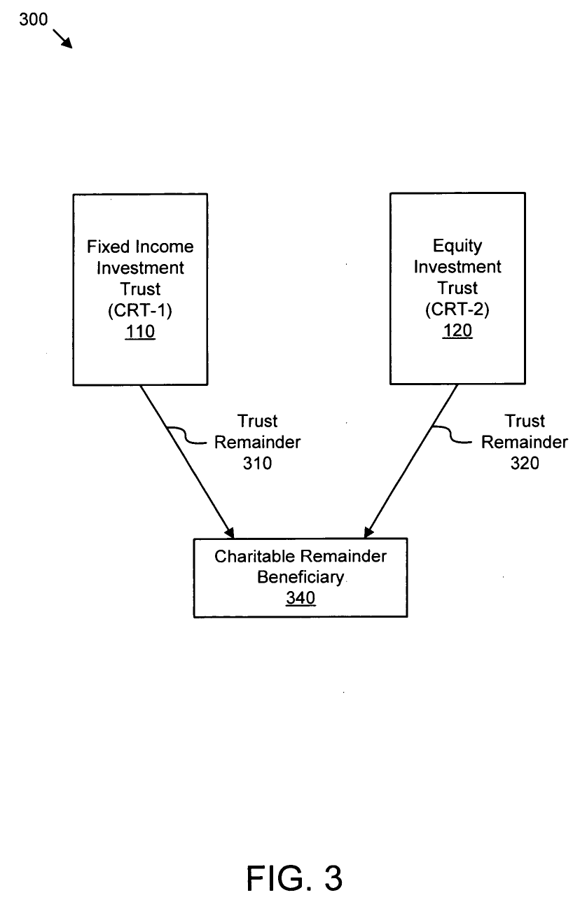

FIG. 3 is a schematic block diagram depicting one embodiment of a distribution system 300 for trust assets following the death of the grantor 102 or other triggering event. As depicted, the distribution system 300 comprises a CRT-1 110, a CRT-2 120, a CRT-1 trust remainder 310, a CRT-2 trust remainder 320, and a charitable remainder beneficiary 340.

Upon the death of the grantor 102, or other triggering event, the assets remaining in the CRT-1 110 and the CRT-2 120 flow tax-free to the charitable remainder beneficiary 340, which may be a family foundation or other qualifying charitable organization.

The grantor 102 may establish a period of years or other triggering event for termination of the CRT-1 110 and CRT-2 120, and the ensuing payout of trust remainders 310 and 320. In a further embodiment, the trust remainders 310 and 320 may remain in the CRT-1 110 and CRT-2 120 to be used for qualifying charitable purposes.

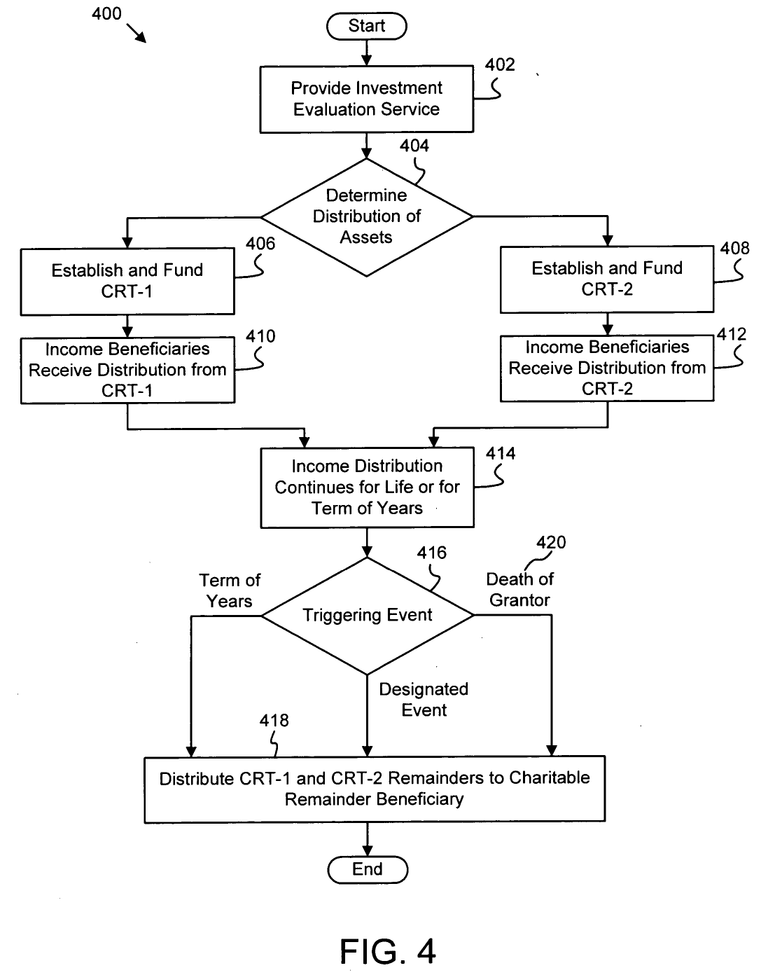

FIG. 4 is a schematic flow chart diagram depicting one embodiment of a method 400 for maximizing income to the grantor 102 through use of a plurality of charitable remainder trusts 110, 120, and, upon the death of the grantor 102, passing the remainder of the estate to a charity. As depicted, the method 400 includes establishing 418 a charitable remainder beneficiary 340, providing 402 an investment evaluation service, determining 404 the distribution of assets 130 and 140, establishing and funding 406 a CRT-1 110, establishing and funding 408 a CRT-2 120, receiving 410 income beneficiary distributions 260 from the CRT-1 110, receiving 412 income beneficiary distributions 260 from the CRT-2-120, income distribution continues 414 for life or for terms of years, the triggering event 416, distributing 418 the CRT-1 remainder 310 to the charitable remainder beneficiary 340, and the CRT-2 remainder 320 to the charitable remainder beneficiary 340, the death 420 of the grantor 102.

Considerations such as risk, growth rate, and tax rate may influence the distribution of assets 130 and 140 between the CRT-1 110 and the CRT-2 120. Risk and growth considerations may also influence the establishment of the trusts as CRUTs, CRATs, or a combination of both.

The grantor 102 may designate a family foundation or other qualifying organization to receive the trust remainders 310 and 320. In a further embodiment, an event other than the death 420 of the grantor 102, such as a term of years, may trigger distribution of the trust remainders 310 and 320. Alternatively, the triggering event may convert CRT-1 110 and CRT-2 120 to qualifying charitable purposes rather than dissolving the CRTs 110 and 120 and distributing the remainders 310 and 320.

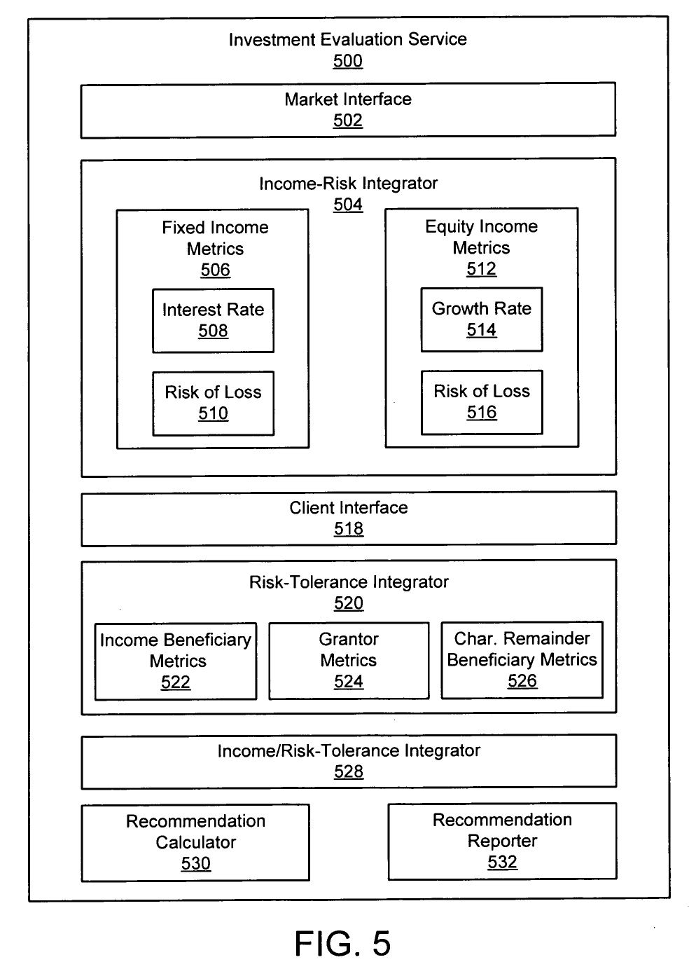

FIG. 5 is a schematic block diagram depicting one embodiment of an investment evaluation service apparatus 500 configured to evaluate the distribution of assets between the CRT-1 110 and the CRT-2 120. As depicted, the apparatus 500 comprises a market interface 502, an income risk integrator 504, fixed income metrics 506, including an interest rate 508 and a risk of loss 510, equity investment metrics 512, including a growth rate 514 and a risk of loss 516, a client interface 518, a risk-tolerance integrator 520, including income beneficiary metrics 522, grantor metrics 524, and charitable remainder beneficiary metrics 526, and income-risk/risk-tolerance integrator 528, and recommendation calculator 530, and a recommendation reporter 532.

In various embodiments, the apparatus 500 may comprise computer software, computer hardware, other signal bearing media or any combination thereof. The apparatus 500 may further comprise modules configured to perform the various functions of the apparatus. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The apparatus 500 may also comprise a combination of electronic and hard-copy elements such as spreadsheets, charts, and financial reports.

In the depicted embodiment, the market interface 502 supplies investment data to the income-risk integrator 504. The data may include income potential such as interest rates 508 for fixed income investments and growth rates 514 for equity investments. The data may also include the risk of loss 510 and 516, as established by a range of analysts and reporting agencies for each of the investments. The income-risk integrator 504 analyzes and integrates the data 506 and 512 for the fixed income and equity investments, respectively, and calculates a current risk benefit indicator for each class of investment. The income-risk integrator 504 then passes the indicators to the income/risk-tolerance integrator 528.

The client interface 518 receives income beneficiary metrics 522, grantor metrics 524, and charitable remainder beneficiary metrics 526 from the relevant entities. The client interface 518 passes the information to the risk-tolerance integrator 520. The risk-tolerance integrator 520 analyzes the metrics 522,524, and 526, and calculates an integrated risk-tolerance indicator. The client interface 518 passes the integrated indicator to the risk-tolerance integrator 520.

The income/risk-tolerance integrator 528 analyzes the investment indicator calculated by the income-risk integrator 504 and the risk-tolerance indicator calculated by the risk-tolerance integrator 520 and calculates an integrated income/risk-tolerance function. The recommendation calculator 530 employs the integrated income-risk/tolerance function to calculate a recommended distribution of assets between the CRT-1 and the CRT-2. The recommendation calculator 530 passes the recommended distribution to the recommendation reporter 532, which passes the recommendation to the client interface 518.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A system for maximizing after tax income on distributions from a plurality of trusts including Charitable Remainder Trusts, (CRT) the system comprising:
a qualified charitable vehicle;
a class of CRT configured to generate ordinary income from fixed income investments, distributions from which are taxed as ordinary income (CRT-1);
a class of CRT configured to generate growth from equity investments, distributions from which are taxed as capital gains income (CRT-2);
a class of CRT configured to generate tax free income or return of principle which is not taxable;
an evaluation service configured to calculate the risk benefit balance between the fixed income and equity class CRTs;
the evaluation service further configured to integrate the risk tolerance of the grantor, an income beneficiary and a charitable remainder beneficiary;
the evaluation service further configured to integrate the risk benefit balance with the integrated risk tolerance so as to balance the lower risk, fixed earnings and higher tax rate on distributions of the fixed income class CRT with the higher risk, variable growth or loss, and lower tax rate on distributions of the equity class CRT; and
the evaluation service further configured to recommend a distribution of grantor's assets between the two classes of CRTs.

2. The system of claim 1, wherein the qualified charitable vehicle is a family foundation.

3. The system of claim 1, wherein the CRT-1 and CRT-2 become active charitable vehicles following the event otherwise triggering dissolution of the trusts and distribution of the remainder to a charitable beneficiary.

4. The system of claim 1, wherein the class CRT-1 comprises an individual trust and the class CRT-2 comprises an individual trust.

5. The system of claim 1, wherein the CRT-1 and CRT-2 are selected from the group consisting of a charitable remainder unitrust and a charitable remainder annuity trust.

6. The system of claim 1, further comprising an electronic calculation module within a computer program configured to calculate the optimum balance of asset distribution between the fixed income trust and the equity investment trust, the calculation module being at least one of digital and analog.

7. The system of claim 6, wherein the electronic calculation module comprises at least one of the groups consisting of standard computer hardware, commercially available computer software, specially designed computer hardware, and specially designed computer software.

8. The system of claim 1, further comprising an insurance trust funded with a wealth replacement life insurance policy.

9. An apparatus for recommending the distribution of assets between the CRT-1 and the CRT-2, the apparatus comprising:
a risk-benefit integrator configured to integrate the potential gain with the risk of loss for at least one of a fixed income investment and an equity investment;
a risk-tolerance integrator configured to calculate the risk tolerance of at least two of the grantor, the income beneficiary, and the charitable remainder beneficiary;
the risk-tolerance integrator further configured to integrate the risk tolerance of at least two of the grantor, the income beneficiary, and the charitable reminder beneficiary; and
an income-risk/risk-tolerance integrator configured to integrate the integrated potential gain and risk of loss of at least one of a fixed income investment and an equity investment with the integrated risk-tolerance of at least two of the grantor, the income beneficiary, and the charitable remainder beneficiary.

10. A method for planning for, funding, and administering a dual set of charitable remainder trusts, the method comprising:
identifying a qualified charitable vehicle:
providing an evaluation service;
calculating the risk benefit balance between fixed income and equity investments
determining the distribution of assets; establishing and funding a fixed income investment CRT; establishing and funding an equity investment CRT:
receiving distributions from the fixed income CRT and the equity investment CRT;
responding to a triggering event;
distributing the remainder of the fixed income investment CRT to the qualifying charitable vehicle; and
distributing the reminder of the equity investment CRT to the qualified charitable vehicle.

11. The method of claim 5, wherein the qualified charitable vehicle is a family foundation.

12. The method of claim 5, wherein the determination of asset distribution is performed via an electronic calculation module.

13. The method of claim 11, wherein the electronic calculation module comprises at least one of the group consisting of standard computer hardware, commercially available computer software and specially designed computer hardware.

14. The method of claim 5, wherein the fixed income CRT and equity investment CRT are at least one of established independently and created through division of the assets of an existing CRT between the existing CRT and a CRT of the opposite class.

15. The method of claim 5, wherein the triggering event is selected from the group consisting of the death of the grantor and a term of years.

16. The method of claim 5, wherein the two classes of CRTs are established as trusts selected from the group consisting of a charitable remainder unitrust and a charitable remainder annuity trust.

17. The method of claim 5, further comprising controlling the percentage of trust income taxed as regular income versus capitol gains by selecting the percentage of assets to be invested in each class of CRT.

18. The method of claim 5, further comprising purchasing a wealth replacement insurance policy on the life of the grantor and paying the premiums from CRT distributions.

19. The method of claim 10, further comprising establishing an insurance trust and funding it with the wealth replacement life insurance policy.

20. The method of claim 11, further comprising paying the insurance proceeds to the beneficiaries upon the death of the grantor.
